(19) United States
(12) Patent Application Publication
(10) Pub. No.: US 2016/0249043 A1
(43) Pub. Date: Aug. 25, 2016

(54) THREE DIMENSIONAL (3D) GLASSES, 3D DISPLAY SYSTEM AND 3D DISPLAY METHOD

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Liguang DENG, Beijing (CN); Xue DONG, Beijing (CN); Hao ZHANG, Beijing (CN); Hyungkyu KIM, Beijing (CN); Rui LIU, Beijing (CN); Yafeng DUAN, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 14/387,688

(22) PCT Filed: Nov. 15, 2013
(86) PCT No.: PCT/CN2013/087198

§ 371 Date: Sep. 24, 2014

(30) Foreign Application Priority Data
Aug. 30, 2013 (CN) 2013 103888985.5

(51) Int. Cl. H04N 13/04; G06F 3/01

(52) U.S. Cl. CPC H04N 13/044; H04N 13/0497; G06F 3/017; A63F 13/52

(57) ABSTRACT

The present disclosure provides 3D glasses, a 3D display system and a 3D display method. The 3D display system of the present disclosure includes a 3D display device and 3D glasses. The 3D glasses include: a 3D image presenting module configured to present a 3D image provided by a 3D display device to a user, a gesture information acquiring module configured to acquire gesture information of the user and supply the gesture information to a gesture information processing module, the gesture information processing module configured to generate processing information according to the gesture information and supply the processing information to an information transmitting module, and the information transmitting module configured to transmit the processing information to the 3D display device.

### CROSS-REFERENCE TO RELATED APPLICATION

This application claims priority to Chinese Patent Application No. 201310388985.5 filed on Aug. 30, 2013, the disclosures of which are incorporated in their entirety by reference herein.

### TECHNICAL FIELD

The present disclosure relates to the field of display technology, in particular to 3D glasses, a 3D display system and a 3D display method.

### BACKGROUND

Currently, three dimensional (3D) display has received a lot of focus. As compared with common 2D display technology, the 3D display technology can provide a realistic, stereo image. The image is no longer limited within a plane of a screen as if it can go beyond the screen, so it can provide audiences with immersive experience. Although with various types, the 3D display technologies share a similar, basic principle, i.e., receiving different images by the left and right eyes of the audience, and synthesizing information of the images by the brain so as to reconstruct the image with a stereo effect in front-rear, up-down, left-right and far-near directions.

The existing 3D display technologies mainly be divided into glass-type and glassless-type ones. The former is based on a left/right-eye stereo imaging technology, i.e., one or two cameras are used to record images viewed by the left and right eyes, respectively, and the audience will wear a corresponding stereo glasses when viewing, so as to view the corresponding left-eye and right-eye images through the left and right eyes, respectively. For the latter, a stereo image is generated based on several rays from a screen at different angles, so the audience may view a 3D image without wearing the glasses. This technology mainly depends on materials of a liquid crystal panel, and thus is also referred to as “passive” 3D technology.

The glass-type 3D technologies may be divided into three main types, i.e., anaglyphic 3D, polarization 3D and active shutter 3D technologies. The glasses using such a technology are just configured to enable the left and right eyes of a user to view different images with tiny parallaxes, thereby providing the user with the 3D image. The glass-type 3D technology is relatively mature, and all of the anaglyphic 3D, polarization 3D and active shutter 3D glasses are available in the market. Especially, the active shutter 3D display technology has attracted much attention, because it can provide excellent display effect, maintain an original resolution of the image and achieve a real, full high definition effect without reducing the brightness of the image.

However, currently, the user can merely browse 3D contents on the screen via the 3D glasses unilaterally and passively, but cannot interact with the viewed 3D contents via the 3D glasses.

### SUMMARY

One technical problem to be solved by the present disclosure is how to enable a user to effectively interact with viewed 3D contents.

In order to solve the above technical problem, according to a first aspect of the present disclosure, 3D glasses are provided and include a 3D image presenting module configured to present a 3D image provided by a 3D display device to a user, a gesture information acquiring module configured to acquire gesture information of the user and supply the gesture information to a gesture information processing module, the gesture information processing module configured to generate processing information according to the gesture information and supply the processing information to an information transmitting module; the information transmitting module configured to transmit the processing information to the 3D display device.

Preferably, the processing information is an operation command or an updated 3D image; the operation command is configured to enable the 3D display device to update the 3D image; the updated 3D image is a 3D image updated according to the gesture information.

Preferably, the 3D image presenting module is a passive 3D lens, a polarization 3D lens or an active shutter 3D lens.

Preferably, the gesture information acquiring module includes an optical depth sensor.

Preferably, the gesture information includes gesture state information and/or hand movement trajectory information.

Preferably, the gesture state information includes a palm-stretching state, a fisted state, a V-shaped gesture state and/or a finger-up state.

Preferably, the hand movement trajectory information presents a precise positioning operation and/or a non-precise positioning operation of the user. The precise positioning operation includes clicking a button on the 3D image or selecting a particular region on the 3D image; the non-precise positioning operation includes hovering the hand, moving the hand from left to right, moving the hand from right to left, moving the hand from top to bottom, moving the hand from bottom to top, separating the hands from each other, putting the hands together, and/or waving the hand.

Preferably, the operation command is configured to control the 3D display device to display in real time a spatially virtual pointer element corresponding to the hand of the user, so that a movement trajectory of the spatially virtual pointer element is identical to a movement trajectory of the user's hand.

Preferably, the gesture information processing module is a model reference fuzzy adaptive control (MRFAC)-based image processor.

Preferably, the information transmitting module uses any one of the communication modes including a universal serial bus, a high definition multimedia interface, Bluetooth, an infrared interface, a wireless home digital interface, a cellular mobile communication network, and WiFi.

According to a second aspect of the present disclosure, a 3D display system is provided and includes a 3D display device for providing a 3D image, and the above-mentioned 3D glasses.

According to a third aspect of the present disclosure, a 3D display method is provided and includes: presenting a 3D image to a user; acquiring gesture information of the user and determining an operation command of the user according to the gesture information; and updating the 3D image according to the operation command and presenting the updated 3D image to the user.

Preferably, the determining an operation command of the user according to the gesture information includes: processing the gesture information to generate processing information; the processing information is the operation command of the user determined according to the gesture information or the updated 3D image.

Preferably, the method is applied to the above-mentioned 3D display system.

Applying the technical solution of the present disclosure, by acquiring the gesture information of the user, determining the operation command of the user according to the gesture information and updating the 3D image viewed by the user according to the operation command, the user may interact with the viewed 3D contents.

### BRIEF DESCRIPTION OF THE DRAWINGS

In order to illustrate technical solutions according to embodiments of the present disclosure or in the prior art more clearly, drawings to be used in the description of the prior art or the embodiments will be described briefly hereinafter. Apparently, the drawings described hereinafter are only some embodiments of the present disclosure, and other drawings may be obtained by those skilled in the art according to those drawings without creative work.

FIG. 1 is a schematic diagram showing a 3D display system according to a first embodiment of the present disclosure;

FIG. 2 is a schematic diagram showing a 3D display system according to a second embodiment of the present disclosure; and

FIG. 3 is a flow chart of a 3D display method according to a third embodiment of the present disclosure.

### DETAILED DESCRIPTION

In order to make objects, technical solutions and advantages of the embodiments of the present disclosure more clear, the technical solutions according to the embodiments of the present disclosure will be clearly and fully described hereinafter in conjunction with the accompanying drawings in the embodiments of the present disclosure. Apparently, the embodiments are only some of the embodiments of the present disclosure, rather than all the embodiments. Based on the described embodiments of the present disclosure, all other embodiments that are acquired by those skilled in the art without inventive work are all within the scope of protection of the present disclosure.

Generally, a special interactive device is required so as to enable a user to enter a virtual environment such as a three dimensional (3D) game. A complete virtual reality system includes a visual system which takes wearable display devices such as 3D glasses, as a core. 3D glasses and a 3D display system provided in embodiments of the present disclosure may enable a user to be immersed in a 3D human-machine natural interaction interface, and enable the user to perform natural information interaction including gesture interaction with the 3D human-machine natural interaction interface.

One embodiment of the present disclosure provides 3D glasses and a 3D display system, so that the user can interact with viewed 3D contents via the 3D glasses. Specifically, when the user views 3D contents provided by a 3D display device, such as a 3D TV or a 3D projection equipment, via the 3D glasses, the user may naturally interact with the viewed 3D contents via gestures through the 3D glasses and relevant modules. The 3D glasses of one embodiment of the present disclosure may be applied to various virtual environments including, but not limited to, 3D games.

### First Embodiment

FIG. 1 is a schematic diagram showing a 3D display system according to a first embodiment of the present disclosure.

As shown in FIG. 1, the 3D display system includes 3D glasses 11 and a 3D display device 12.

The 3D display device 12 is configured to provide a 3D image, and may be a 3D TV, a 3D projection equipment or other 3D display equipment.

The 3D glasses 11 may be in various forms, and may include elements such as a frame and lenses. In addition, the 3D glasses 11 include a 3D image presenting module 111, a gesture information acquiring module 112, a gesture information processing module 113 and an information transmitting module 114. These modules may be arranged at any appropriate position on the frame, e.g., on a rim or a leg.

The 3D image presenting module 111 is configured to present a 3D image provided by the 3D display device 12 to a user, so as to provide the user with a 3D display interface. The 3D image presenting module 111 may be implemented as a passive red-blue filtering 3D lens, a passive red-green filtering 3D lens, a passive red-cyan filtering 3D lens, a polarization 3D lens, or an active shutter 3D lens.

The gesture information acquiring module 112 is configured to acquire gesture information made by the user when the user browses the 3D display interface, and supply the gesture information to the gesture information processing module 113. The gesture information acquiring module 112 may include one or more optical depth sensors (e.g., cameras), so as to acquire in real time a depth image of a hand or hands of the user. In order to collect the user's gestures fully and integrally, preferably two optical depth sensors are used. For example, one of the optical depth sensors is arranged at a joint between one end of an upper side of the frame and a front end of one leg, and the other optical depth sensor is arranged at a joint between the other end of the upper side of the frame and a front end of the other leg.

The gesture information may include gesture state information and/or hand movement trajectory information. The gesture state information may include a palm-stretching state, a fisted state, a V-shaped gesture state and/or a finger-up (thumb-up or other finger-up) state. The hand movement trajectory information may present a precise positioning operation and/or a non-precise positioning operation of the user. The precise positioning operation may include: clicking a button on the 3D image and/or selecting a particular region on the 3D image. In order to identify the precise operation, it is required to track in real time the movement trajectory of the user's hand, represent the movement trajectory of the user's hand with a pointer element on the interaction interface so as to determine a position of an element intended for interaction on the interaction interface, and analyze and determine an intention of the movement trajectory of the user's hand to obtain an interaction command, thereby realizing precise operation on the interface. For an identification of the non-precise positioning operation, it is merely required to record and analyze the movement trajectory of the hand. For example, the non-precise positioning operation may include hovering the hand, moving the hand from left to right, moving the hand from right to left, moving the hand from top to bottom, moving the hand from bottom to top, separating the hands from each other, putting the hands together, and/or waving the hand(s), so as to issue a command such as “page down/up”, “forward” and “backward”.

The gesture information processing module 113 is configured to determine interactive intention information of the user according to the gesture information, generate a corresponding operation command (processing information), and supply the operation command (processing information) to the information transmitting module 114. The gesture information processing module 113 may determine an interactive operation command corresponding to the gesture information of the user by a series of interactive software for user identification. In addition, the interactive software for user identification may further provide an operation interface customized by the user. For example, a specific, user's favorite gesture is used to represent a certain operation command customized by the user, so as to provide a personalized and customized system. For example, correspondence between the user's gesture and the respective interactive operation command may be pre-set in the interactive software for user identification, and this correspondence is preferably editable so as to add new interactive operation commands conveniently, or change the gesture corresponding to the interactive operation command according to user's habits.

Due to the diversity and non-standardability of the gestures, an identical gesture may be made by different persons in different ways, and even when the gesture is made by the same person several times, it will not always be the same. In order to accurately distinguish each gesture, preferably, the gesture information processing module 113 adopts a model reference fuzzy adaptive control (MRFAC)-based image processor. The image processor adopts a MRFAC method to process the image. Based on a common fuzzy controller, such a MRFC method is further provided with an auxiliary fuzzy controller for modifying a rule base of the common fuzzy controller on line using a difference between an output of a reference model and an output of an actually controlled object, so as to improve the robustness of the system against parameter uncertainty.

The operation command is used to control the 3D display device 12 to display in real time a spatially virtual pointer element corresponding to the user's hand, so that a movement trajectory of the spatially virtual pointer element is identical to the movement trajectory of the user's hand. It should be appreciated that, based on the above contents in combination with the prior art, a person skilled in the art is capable of realize how to display the spatially virtual pointer element of the user's hand and how to make the movement trajectories thereof identical to each other, which will not be repeated herein.

The information transmitting module 114 is configured to transmit the operation command (processing information) to the 3D display device 12. The information transmitting module 114 may be implemented in various modes, including but not limited to a universal serial bus, a high definition multimedia interface, Bluetooth, an infrared interface, a wireless home digital interface, a cellular mobile communication network, and WiFi.

According to this embodiment, when the hand of the user who wears the 3D glasses 11 enters a detection range of the gesture information acquiring module 112, the gesture information acquiring module 112 acquires in real time depth image sequences of the user's hand and transmits them to the gesture information processing module 113. The gesture information processing module 113 analyzes in real time the depth image sequences of the user's hand using a series of software matching recognition algorithms so as to obtain the movement trajectory of the user's hand, determines an interactive intention of the user using a series of redundant action matching algorithms based on spatial positions and state information of the user's hand so as to generate the corresponding operation command, and supplies the operation command to the information transmitting module 114. It should be appreciated that, based on the above contents in combination with the prior art, a person skilled in the art is capable of realizing the above processing of the gesture information processing module 113. Hence, how to acquire the movement trajectory of the user's hand and how to acquire the interactive intention of the user by the gesture information processing module 113 will not be repeated herein.

In this embodiment, an image source of the 3D display device 12 is not the 3D glasses 11. The gesture information processing module 113 determines the interactive operation command corresponding to the gesture information, and transmits the interactive operation command to the 3D display device 12 via the information transmitting module 114. At this time, the 3D display device 12 may control a 3D image acquired from the image source to perform the interaction operation according to the interactive operation command, and display the 3D image upon which the interactive operation command is performed. In this embodiment, the 3D glasses 11 do not provide 3D images to the 3D display device 12, and , the 3D glasses 11 merely determine the interactive operation command corresponding to the gesture information and transmits the interactive operation command to the 3D display device 12 via the information transmitting module 114. At this time, the 3D display device 12 performs the interactive operation command on the 3D image acquired from the image source, and displays the 3D image upon which the interactive operation command is performed. The 3D image upon which the interactive operation command is performed may be presented to the user via the 3D glasses 11.

### Second Embodiment

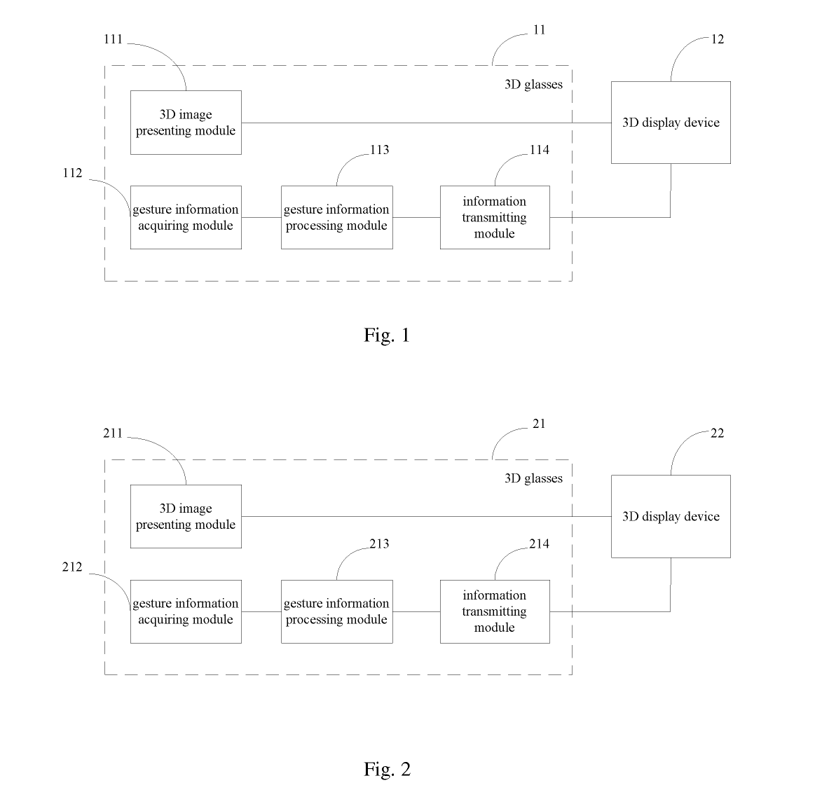

FIG. 2 is a schematic diagram showing a 3D display system according to a second embodiment of the present disclosure.

As shown in FIG. 2, the 3D display system includes 3D glasses 21 and a 3D display device 22.

The 3D display device 22 is configured to provide a 3D image, and may be a 3D TV or a 3D projection equipment or other 3D display equipment.

Comparing with the 3D glasses 11 of the first embodiment, similarly, the 3D glasses 21 of this embodiment include a 3D image presenting module 211, a gesture information acquiring module 212, a gesture information processing module 213, and an information transmitting module 214. Comparing with the 3D glasses 11 of the first embodiment, a difference is in that the gesture information processing module 213 in the 3D glasses 21 of this embodiment does not directly transmit an operation command to the 3D display device 22 via the information transmitting module 214, and instead, the gesture information processing module 213 first updates the 3D image according to the operation command and then transmits the updated 3D image to the 3D display device 22 via the information transmitting module 214.

In this embodiment, an image source of the 3D display device 22 is the 3D glasses 21. The gesture information processing module 213 determines an interactive operation command corresponding to the gesture information, updates the 3D image according to the interactive operation command, and then transmits the updated 3D image to the 3D display device 22 via the information transmitting module 214. In this embodiment, apart from determining the interactive operation command corresponding to the gesture information, the 3D glasses 21 further provide the 3D display device 22 with an original 3D image and the updated 3D image. The 3D display device 22 displays the updated 3D image, and the updated 3D image may be presented to the user via the 3D glasses 21.

### Third Embodiment

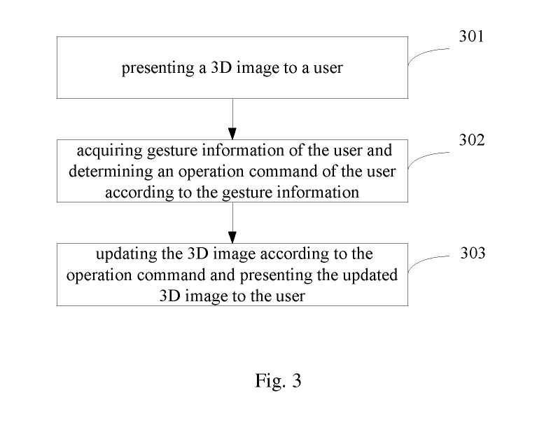

FIG. 3 is a flow chart of a 3D display method according to a third embodiment of the present invention.

As shown in FIG. 3, the 3D display method includes:

Step S301: presenting a 3D image to a user;

Step S302: acquiring gesture information of the user and determining an operation command of the user according to the gesture information; and

Step S303: updating the 3D image according to the operation command and presenting an updated 3D image to the user.

Specifically, the 3D display method may be implemented by the 3D display system according to the first or second embodiment as well as the 3D glasses.

When the 3D display system is used by the user, an original 3D image is first displayed on the 3D display device.

At this time, the user can view the original 3D image via the 3D image presenting module on the 3D glasses.

When the user gives a gesture interacting with the original 3D image, the gesture information acquiring module acquires the gesture information, and supplies the gesture information to the gesture information processing module.

Then, the gesture information processing module determines an operation command of the user according to the gesture information, and directly supplies the operation command to the 3D display device. The 3D display device performs the interactive operation command on the 3D mage acquired from the image source, and displays the updated 3D image upon which the interactive operation command is performed. Alternatively, the gesture information processing module updates the 3D image according to the operation command, and then transmits the updated 3D image to the 3D display device.

Finally, the updated 3D image may be presented to the user via the 3D glasses.

It can be seen, after applying embodiments of the present disclosure, when the user views 3D contents via the 3D display device such as a 3D TV or a 3D projection equipment, the user may interact with the viewed 3D contents by using the 3D glasses to capture gestures.

It should be appreciated that, the above embodiments are merely for illustrative purposes, but shall not be used to limit the present disclosure. Although the present disclosure is described hereinabove in conjunction with the embodiments, a person skilled in the art may make further modifications and substitutions, without departing from the spirit and scope of the present invention. If these modifications and substitutions fall within the scope of the appended claims and the equivalents thereof, the present invention also intends to include them.

What is claimed is:

1. Three dimensional (3D) glasses comprising:
a 3D image presenting module, a gesture information acquiring module, a gesture information processing module and an information transmitting module;
the 3D image presenting module configured to present a 3D image provided by a 3D display device to a user;
the gesture information acquiring module configured to acquire gesture information of the user and supply the gesture information to the gesture information processing module;
the gesture information processing module configured to generate processing information according to the gesture information and supply the processing information to the information transmitting module; and
the information transmitting module configured to transmit the processing information to the 3D display device.

2. The 3D glasses according to claim 1, wherein the processing information is an operation command determined according to the gesture information or an updated 3D image; the operation command is configured to enable the 3D display device to update the 3D image; the updated 3D image is a 3D image updated according to the gesture information.

3. The 3D glasses according to claim 1, wherein the 3D image presenting module is a passive 3D lens, a polarization 3D lens or an active shutter 3D lens.

4. The 3D glasses according to claim 3, wherein the gesture information acquiring module comprises an optical depth sensor.

5. The 3D glasses according to claim 1, wherein the gesture information comprises gesture state information and/or hand movement trajectory information.

6. The 3D glasses according to claim 5, wherein the gesture state information includes a palm-stretching state, a fisted state, a V-shaped gesture state and/or a finger-up state.

7. The 3D glasses according to claim 5, wherein the hand movement trajectory information presents a precise positioning operation and/or a non-precise positioning operation of the user; wherein the precise positioning operation comprises clicking a button on the 3D image and/or selecting a particular region on the 3D image, and the non-precise positioning operation comprises hovering the hand, moving the hand from left to right, moving the hand from right to left, moving the hand from top to bottom, moving the hand from bottom to top, separating the hands from each other, putting the hands together, and/or waving the hand.

8. The 3D glasses according to claim 2, wherein the operation command is configured to control the 3D display device to display in real time a spatially virtual pointer element corresponding to the hand of the user, so that a movement trajectory of the spatially virtual pointer element is identical to a movement trajectory of the user's hand.

9. The 3D glasses according to claim 1, wherein the gesture information processing module is a model reference fuzzy adaptive control (MRFAC)-based image processor.

10. The 3D glasses according to claim 1, wherein the information transmitting module uses any one of communication modes including a universal serial bus, a high definition multimedia interface, Bluetooth, an infrared interface, a wireless home digital interface, a cellular mobile communication network, and WiFi.

11. A three dimensional (3D) display system, comprising:
a 3D display device configured to provide a 3D image; and
3D glasses according to claim 1.

12. A three dimensional (3D) display method, comprising:
presenting a 3D image to a user;
acquiring gesture information of the user and determining an operation command of the user according to the gesture information; and
updating the 3D image according to the operation command and presenting the updated 3D image to the user.

13. The 3D display method according to claim 12, wherein the determining an operation command of the user according to the gesture information comprises:
processing the gesture information to generate processing information; wherein the processing information is the operation command of the user determined according to the gesture information or the updated 3D image.

14. The 3D display method according to claim 12, wherein the method is applied to a 3D display system comprising a 3D display device configured to provide a 3D image; and 3D glasses comprising a 3D image presenting module, a gesture information acquiring module, a gesture information processing module and an information transmitting module;
the 3D image presenting module configured to present a 3D image provided by a 3D display device to a user;
the gesture information acquiring module configured to acquire gesture information of the user and supply the gesture information to the gesture information processing module;
the gesture information processing module configured to generate processing information according to the gesture information and supply the processing information to the information transmitting module; and
the information transmitting module configured to transmit the processing information to the 3D display device.

15. The 3D glasses according to claim 2, wherein the 3D image presenting module is a passive 3D lens, a polarization 3D lens or an active shutter 3D lens.

16. The 3D glasses according to claim 5, wherein the gesture information acquiring module comprises an optical depth sensor.

17. The 3D glasses according to claim 2, wherein the gesture information comprises gesture state information and/or hand movement trajectory information.

18. The 3D glasses according to claim 2, wherein the gesture information processing module is a model reference fuzzy adaptive control (MRFAC)-based image processor.

19. The 3D glasses according to claim 2, wherein the information transmitting module uses any one of communication modes including a universal serial bus, a high definition multimedia interface, Bluetooth, an infrared interface, a wireless home digital interface, a cellular mobile communication network, and WiFi.
